(19) United States
(12) Patent Application Publication
(10) Pub. No.: US 2016/0371106 A1
(43) Pub. Date: Dec. 22, 2016

(54) VIRTUAL MACHINE DATA PROTECTED FROM HOST

(71) Applicant: Microsoft Technology Licensing, LLC, Redmond, WA (US)

(72) Inventors: David Alan Hepkin, Redmond, WA (US); Shreyas Srivatsan, Ossining, NY (US)

(21) Appl. No.: 14/743,567

(22) Filed: Jun. 18, 2015

(51) Int. Cl. G06F 9/455

(52) U.S. Cl. CPC G06F 9/45545; G06F 9/45558; G06F 2009/4557; G06F 2009/45583

(57) ABSTRACT

The secure making available of virtual machine data of a virtual machine operating to a host computing system. In order to make such data available to the host operating system, a component that is not native to the host operating system intercepts a command to make available the data that is within a protected portion of the host memory. In response, the component encrypts and makes the data available to the host operating system. Once the virtual machine data enters the domain of the host operating system the data remains encrypted while in custody of the host operating system. To make received encrypted virtual data available to the virtual machine, the component causes the encrypted data to be decrypted and made available to the virtual machine.

### BACKGROUND

Computing systems have changed the way in which human beings work, play, communicate, problem solve, and so forth. Traditionally, computing systems have processed and stored information locally on a single physical computer. With the advent of the internet, however, services (such as processing and storage service) are offered remotely, thereby allowing a local computing system to offload processing, storage, or other tasks to the services offered over the network. Such services may be offered by a single server or by a network of servers.

Even more recently, cloud-based computing environments (often referred to as simply “the cloud”) have become available. The cloud is so termed because from a user perspective, the user may at least conceptually reach up into the sky using the device from practically any location and extract the desired service. Of course, complex networks of hardware are required in order to provide this illusion.

For instance, a cloud computing environment typically includes one or more, and often numerous, host computing systems, which are physical. The host computing system runs thereon a host operating system. The host operating system may run applications, such as virtual machine applications.

The virtual machine application emulates an entire computing system (hence the term “virtual machine”) to a remote user. While the host computing system has thereon physical hardware, such as processors, memory, storage, network interface cards, and so forth, the virtual machines do not directly access such hardware. Instead, the virtual machines call into a hypervisor, which provides only the appearance that the virtual machine is interacting directly with hardware. For instance, the hypervisor might provide the appearance that the virtual machine has access to a storage device. Such appearance might be termed a “virtual storage device”. The same applies for other hardware capabilities as well.

In addition to emulation of hardware, the hypervisor also ensures separation of data in the case where the various virtual machines are serving clients whose data should not be shared. For instance, suppose a user of one virtual machine is from one corporation, and a user of a second virtual machine is from another corporation. The first and second virtual machines should not share data, at least not without consent. Accordingly, the hypervisor ensures such data isolation.

From a user perspective, the user simply interacts with the local device as if there were a direct interaction with a physical computing system that is not emulated by the virtual machine. The user need not be aware of the remoteness of the processing or the data at all.

Each host computing system has an associated host administrator that performs administrative tasks with respect to the host computing system as a whole. As such, the host administrator may perform tasks normally permitted by the host operating system, including interactions with the virtual machine and the hypervisor.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to the secure making available of virtual machine data to a host operating system operating within the context of the corresponding virtual machine that owns the data operating within a host computing system. For instance, the host operating system might not be able to even access the virtual machine data in the clear. Rather, when sending and receiving or otherwise accessing the virtual machine data, the host operating system sees the encrypted form of the virtual machine data. Thus, host administrators cannot easily see the proprietary information of the virtual machine. The accessing of such data occurs in a context in which the virtual machine operating system has access to a protected portion of host memory that cannot be seen during normal modes of the host operating system, and the clear form of the virtual machine data is present within the protected portion of host memory.

In order to make the virtual machine data available (such as when sending), a component that is not native to the host operating system intercepts a command to make available the virtual machine data that is within that protected portion of the host memory. In response, the component causes the virtual machine data to be encrypted prior to being made available to the host operating system. Once the virtual machine data enters the domain of the host operating system in preparation (e.g., in preparation for sending), the host operating system sees only the encrypted form of the data.

At least some embodiments described may alternatively, or in addition, relate to receiving. In order to receive, a component (perhaps the same component that was used to send or otherwise make the data available to the host operating system) that is not native to the host operating system receives encrypted data and such remains encrypted while in custody of the host operating system. However, the component causes the encrypted data to be decrypted and made available to the virtual machine. Thus, again, the clear form of the virtual machine data is not seen during normal modes of the operating system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates a computing system in which some embodiments described herein may be employed.

FIG. 2 abstractly illustrates a cloud computing environment in which some embodiments described herein may be employed.

FIG. 3 abstractly illustrates a host computing system in which embodiments presented herein may be employed.

FIG. 4 illustrates an example flow diagram for making virtual machine data securely available to a host operating system.

FIG. 5 illustrates an example flow diagram for receiving encrypted data.

FIG. 6 illustrates an example flowchart of a method for making virtual machine data securely available to a host operating system.

FIG. 7 illustrates an example flowchart of a method for a virtual machine to receive encrypted data.

### DETAILED DESCRIPTION

At least some embodiments described herein relate to the secure making available of virtual machine data to a host operating system operating within the context of the corresponding virtual machine that ows the data operating within a host computing system. For instance, the host operating system might not be able to even access the virtual machine data in the clear. Rather, when sending and receiving or otherwise accessing the virtual machine data, the host operating system sees the encrypted form of the virtual machine data. Thus, host administrators cannot easily see the proprietary information of the virtual machine. The accessing of such data occurs in a context in which the virtual machine operating system has access to a protected portion of host memory that cannot be seen during normal modes of the host operating system, and the clear form of the virtual machine data is present within the protected portion of host memory.

In order to make the virtual machine data available (such as when sending), a component that is not native to the host operating system intercepts a command to make available the virtual machine data that is within that protected portion of the host memory. In response, the component causes the virtual machine data to be encrypted prior to being made available to the host operating system. Once the virtual machine data enters the domain of the host operating system in preparation (e.g., in preparation for sending), the host operating system sees only the encrypted form of the data.

At least some embodiments described may alternatively, or in addition, relate to receiving. In order to receive, a component (perhaps the same component that was used to send or otherwise make the data available to the host operating system) that is not native to the host operating system receives encrypted data and such remains encrypted while in custody of the host operating system. However, the component causes the encrypted data to be decrypted and made available to the virtual machine. Thus, again, the clear form of the virtual machine data is not seen during normal modes of the operating system.

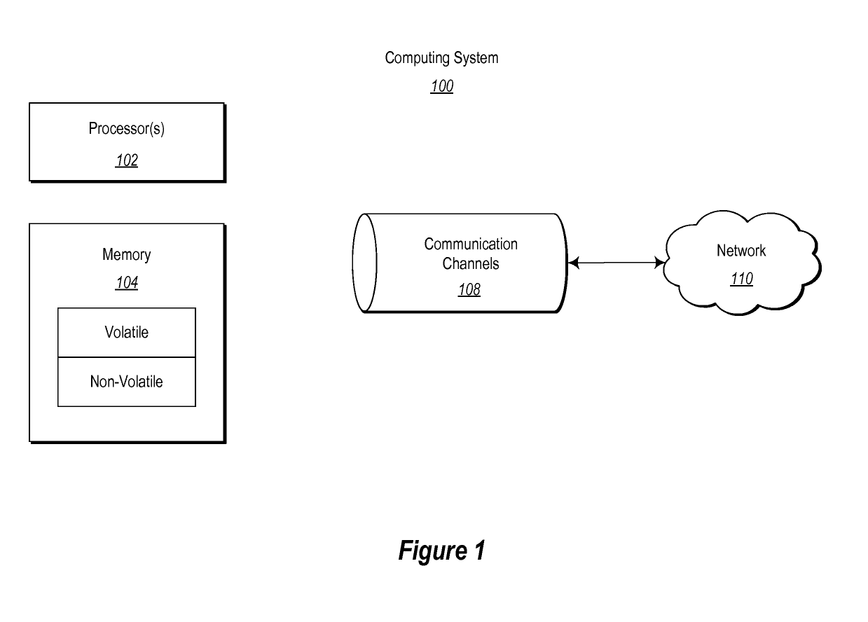

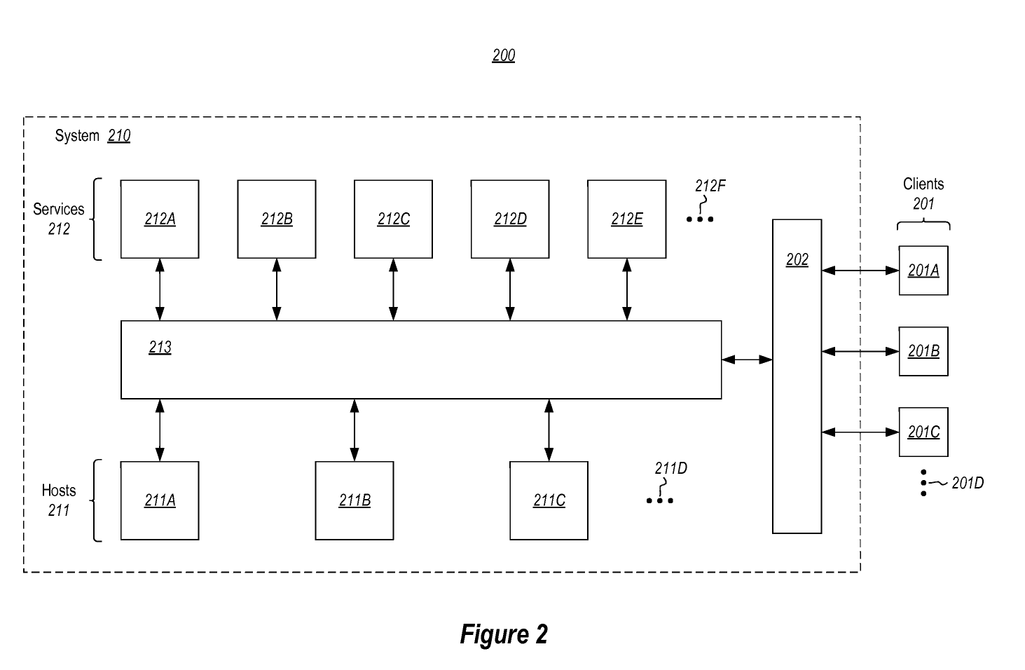

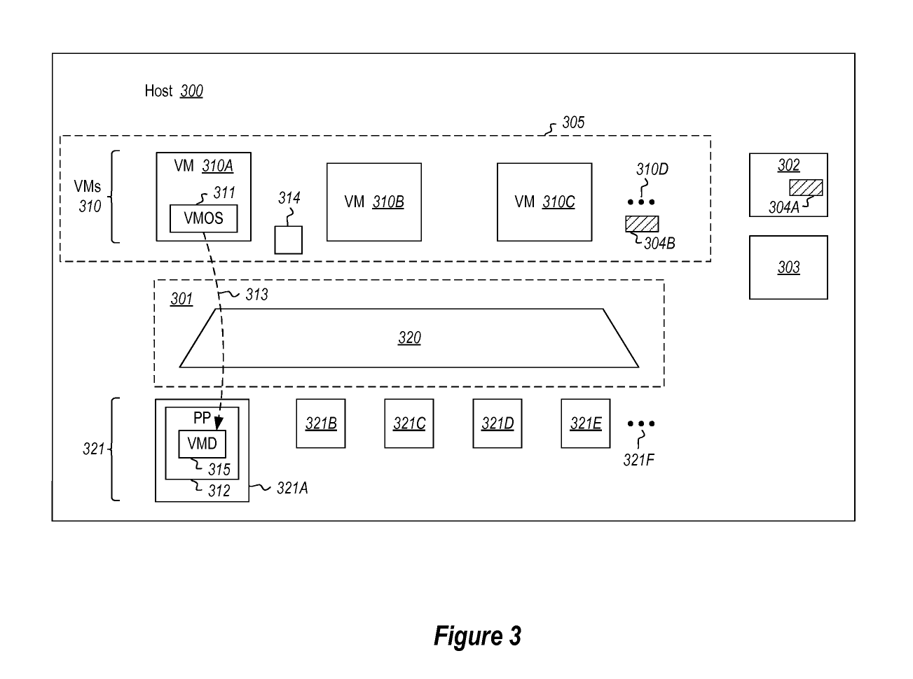

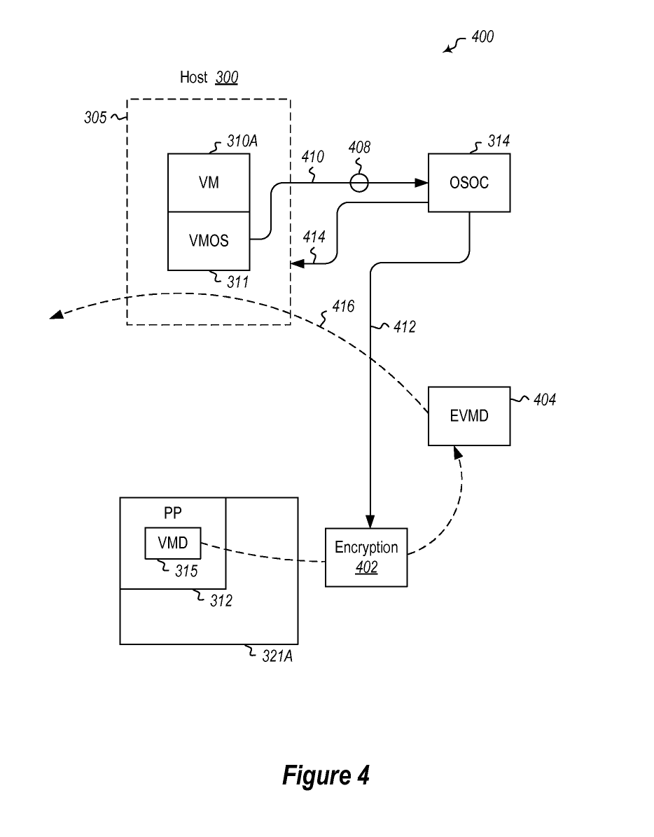

Some introductory discussion of a computing system will be described with respect to FIG. 1. Thereafter, an example cloud computing environment will be described with respect to FIG. 2. Then, an example host computing system that has thereon operating virtual machines will be described with respect to FIG. 3. The principles of securely sending and receiving virtual machine data or otherwise make the data available to the host operating system in a manner hidden from the host will then be described with respect to FIGS. 4 through 7.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 abstractly illustrates an environment 200 in which the principles described herein may be employed. The environment 200 includes multiple client computing systems, or clients 201, interacting with a system 210 using an interface 202. The environment 200 is illustrated as having three clients 201A, 201B and 201C, although the ellipses 201D represent that the principles described herein are not limited to the number of clients interfacing with the system 210 through the interface 202. The system 210 may provide services to the clients 201 on-demand and thus the number of clients 201 receiving services from the system 210 may vary over time.

Each client 201 may, for example, be structured as described above for the computing system 100 of FIG. 1. Alternatively or in addition, the client may be an application or other software module that interfaces with the system 210 through the interface 202. The interface 202 may be an application program interface that is defined in such a way that any computing system or software entity that is capable of using the application program interface may communicate with the system 210.

The system 210 may be a distributed system, although not required. In one embodiment, the system 210 is a cloud computing environment. Cloud computing environments may be distributed, although not required, and may even be distributed internationally and/or have components possessed across multiple organizations.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

The system 210 includes multiple hosts 211, that are each capable of running virtual machines. Although the system 200 might include any number of hosts 211, there are three hosts 211A, 211B and 211C illustrated in FIG. 2, with the ellipses 211D representing that the principles described herein are not limited to the exact number of hosts that are within the system 210. There may be as few as one, with no upper limit. Furthermore, the number of hosts may be static, or might dynamically change over time as new hosts are added to the system 210, or as hosts are dropped from the system 210. Each of the hosts 211 may be structured as described above for the computing system 100 of FIG. 1.

Each host is capable of running one or more, and potentially many, virtual machines. For instance, FIG. 3 abstractly illustrates a host, host computing system 300, in further detail. As an example, the host computing system 300 might represent any of the hosts 211 of FIG. 2. In the case of FIG. 3, the host computing system 300 is illustrated as operating three virtual machines 310 including virtual machines 310A, 310B and 310C. However, the ellipses 310D once again represents that the principles described herein are not limited to the number of virtual machines running on the host computing system 300. There may be as few as zero virtual machines running on the host with the only upper limit being defined by the physical capabilities of the host computing system 300.

During operation, the virtual machine emulates a fully operational computing system including at least one operating system, and perhaps one or more other applications as well. Each virtual machine is assigned to a particular client, and is responsible to support the desktop environment for that client.

The virtual machine generates a desktop image or other rendering instructions that represent a current state of the desktop, and then transmits the image or instructions to the client for rendering of the desktop. For instance, referring to FIGS. 2 and 3, suppose that the host computing system 300 of FIG. 3 represents the host 211A of FIG. 2, and that the virtual machine 310A is assigned to client 201A (referred to herein as “the primary example”), the virtual machine 310A might generate the desktop image or instructions and dispatch such instructions to the corresponding client 201A from the host 211A via a service coordination system 213 and via the system interface 202.

As the user interacts with the desktop at the client 201A, the user inputs are transmitted from the client 201A to the virtual machine 310A. For instance, in the primary example and referring to FIGS. 2 and 3, the user of the client 201A interacts with the desktop, and the user inputs are transmitted from the client 201A to the virtual machine 310A via the interface 202, via the service coordination system 213 and via the host 211A.

The virtual machine 310A processes the user inputs and, if appropriate, changes the desktop state. If such change in desktop state is to cause a change in the rendered desktop, then the virtual machine 310A alters the image or rendering instructions, if appropriate, and transmits the altered image or rendered instructions to the client computing system 201A for appropriate rendering. From the prospective of the user, it is as though the client computing system 201A is itself performing the desktop processing.

In the illustrated example, the services 200 include five distinct services 212A, 212B, 212C, 212D and 212E, although the ellipses 212F represent that the principles described herein are not limited to the number of service in the system 210. A service coordination system 213 communicates with the hosts 211 and with the services 212 to thereby provide services 212 as requested by the clients 201, and other services (such as authentication, billing, and so forth) that may be prerequisites for the requested service.

The host computing system 300 includes a hypervisor 320 that emulates virtual resources for the virtual machines 310 using physical resources 321 that are abstracted from view of the virtual machines 310. The hypervisor 320 also provides proper isolation between the virtual machines 310. Thus, from the perspective of any given virtual machine, the hypervisor 320 provides the illusion that the virtual machine is interfacing with a physical resource, even though the virtual machine only interfaces with the appearance (e.g., a virtual resource) of a physical resource, and not with a physical resource directly. In FIG. 3, the physical resources 321 are abstractly represented as including resources 321A through 321F. Examples of physical resources 321 include processing capacity, memory, disk space, network bandwidth, media drives, and so forth. For instance, in the example below, resource 321A is host memory.

The host computing system 300 may operate a host agent 302 that monitors the performance of the host computing system 300, and performs other operations that manage the host computing system 300. Additionally, the host computing system 300 may operate other components 303. The host computing system 300 may include a host operating system 305 that operates various applications. For instance, the applications could be virtual machines such as virtual machines 310A through 310D. The host agent 302 may also perform operations directed to the applications and virtual machines 310A through 310D.

Unfortunately, elements of the host may operate to violate reasonable expectations of privacy of the virtual machine 310 data. For instance, a rogue party may plant malware 304A or 304B to gain access to or takes over a host agent's access rights. The malware components 304A and 304B are illustrated as having cross-hatched filler to emphasize that these components are unwanted within the host computing system 300. Thus, the undesirable malware 304A or 304B is permitted opportunities to perform operations rightfully belonging to the host agent 302. As shown, undesirable third party host agent 304A may be present in the host computing system 300. Alternatively, or in addition, undesirable third party host agent 304B may be present in the host operating system 305. Even the host users themselves might use the host agent 302 in an attempt to view private data of the virtual machine. This represents a security violation, as virtual machine owners expect their data to be private from all parties, including often the host. By encrypting virtual machine data that the host operating system sees, host administrators, and thus undesirable third party agents 304A and 304B, cannot easily see or access the proprietary information of the virtual machine.

The virtual machine 310A operates thereon virtual machine operating system 311 that has access to a “protected portion” 312 of host memory 321A allocated for use by the virtual machine operating system 311. Such allocation is represented symbolically in FIG. 3 by the arrow 313. The “protected portion” 312 of host memory 321A is defined as a memory space that is restricted in use such that it is not available to others, including the host manager and undesirable third party agents, in the host computing system 300, unless they have the same access privileges (e.g., two virtual machines belonging to the same customer or “tenant”).

In this description and in the claims, software or other modules running on the host computing system in a “secure operating mode” are able to access the protected portion 312 of host memory 321A, whereas software or other modules running the host computing system in a “normal operating mode” are not able to access the protected portion 312 of host memory 321A. The normal operating mode is the normal or usual operating state in which the host computing system 300 runs. This normal operating mode and secure operating mode are modes of operation that can be provided by hardware or software. For example, the hypervisor could provide these two operating modes and ensure that the normal/standard host operating system is only able to run in the “normal operating mode” and thus does not have access to the secure memory. Only secure operating system components that are not part of the normal operating system can run in the secure operating mode.

This description will now show how virtual machine data may be sent or otherwise made available to the host operating system 305 in a manner that prevents the host operating system 305 from viewing the virtual machine data (e.g., such as when the virtual machine data is externally sent from the host computing system 300, and when virtual machine data is received into the host computing system). That said, the principles described herein apply to prevent any component operating in normal operating mode within the host computing system from seeing the virtual machine data, regardless of whether that data is being transmitted or received. This may be helpful when the host sends or receives such virtual machine data, but is also helpful whenever the virtual machine data is to be kept from the view (except in encrypted form) of the host operating system (such as for purposes of migrating the virtual machine). First, the perspective of securely making the virtual machine data in encrypted for to the host operating system will be described.

In order to make virtual machine data 315 available, virtual machine data 315 that originates in the protected portion 312 of host memory 321A may be accessed by an “operating system opaque component” 314. In this description and in the claims, an “operating system opaque” component is defined as a component that is not native to the host operating system 305 or the virtual machine operating system 311. For instance, the host operating system 305 or virtual machine operating system 311 may be changed and updated without affecting the operating system opaque component 314. When incorporating one or more operating system opaque components, or other emulated devices, into the host computing system 300, there may be no change to a Kernel of the host operating system 305 or to the particular virtual machine operating system 311. The operating system opaque component 314 may be located within a protected portion 312 of a host partition that cannot be accessed through the normal operating mode of the host operating system.

The operating system opaque component 314 responds to commands regarding the virtual machine data 315 that is within the protected portion 312 of host memory 321A. The commands may be issued by the virtual machine operating system 311 or by other sources, including sources within the host computing system 300 or outside the host computing system 300.

FIG. 4 illustrates an example flow diagram 400 for making the virtual machine data 315 available (such as when sending the data from virtual machine 310A) within a context in which the virtual machine operating system 311 has access to the protected portion 312 of host memory 321A that cannot be seen during normal modes of the host operating system 305. As used herein, to “make available” means to securely make the virtual machine data available in encrypted form to the host operating system. To “externally send” the virtual machine data is to send virtual machine data 315 from a protected portion 312 of host memory 321A to an environment outside of the host computing system 300.

The flow diagram 400 is performed by the operating system opaque component 314. For instance, the operating system opaque component 314 could be the hypervisor 320, or a system or component of firmware that is outside of the hypervisor 320. The operating system opaque component 314 might alternatively be a driver registered with the virtual machine operating system 311. For instance, the driver may be loaded at or after startup of the virtual machine operating system 311 using the existing host operating system 305. In this case, the operating system opaque component 314 may perform the method 400 by emulating physical hardware to the virtual machine operating system 311.

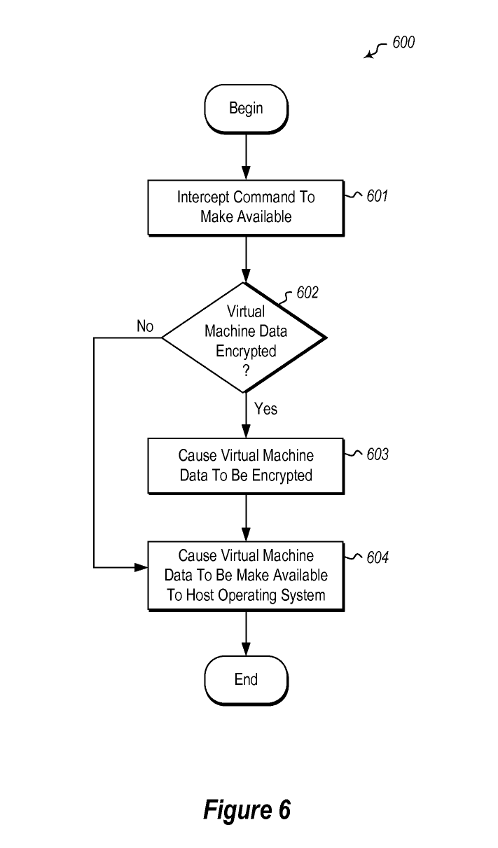

The flow diagram represents flows that may occur when performing a method for making the virtual machine data 315 available to the host operating such (such as when sending the virtual machine data or migrating the virtual machine). FIG. 6 illustrates a flowchart for a method 600 of making the virtual machine data 315 available to the host operating such (such as when sending the virtual machine data or migrating the virtual machine). Accordingly, the flowchart of the method 600 of FIG. 6 will be described along with the data flow 400 of FIG. 4.

Referring to FIG. 6, the operating system opaque component 314 first intercepts a command to make the virtual machine data 315 that is within the protected portion 312 available to the host operating system (act 601). For instance, in FIG. 4, for the case of sending and receiving, the operating system opaque component 314 intercepts (as represented by the circle 408) a command 410 that is issued by the virtual machine operating system 311. In a normal operating state or mode, this step may be performed any number of times to accumulate data prior to further processing the steps herein. For migration of a virtual machine, the migration may be triggered by the administrator in the host operating system rather than something running in the guest operating system.

If the operating system opaque component 314 is a component that is outside of the hypervisor 320, the operating system opaque component 314 may perform the act of intercepting the command by receiving the command from the hypervisor 320 in response to the hypervisor 320 receiving the command from the virtual machine operating system 311. If the data is to be encrypted (“Yes” in decision block 602), then the operating system opaque component 314 responds to this interception by causing the virtual machine data 315 to be encrypted (act 603). For instance, in FIG. 4, the operating system opaque component 314 controls (as represented by arrow 412) an encryption process 402 to receive the virtual machine data 315 and formulate an encrypted form 404 of the virtual machine data 315.

The decision regarding whether or not to encrypt may be a split decision, whereby some virtual machine data is to be encrypted and the remaining virtual machine data is to be left unencrypted. In other words, there may be at least one circumstance in which virtual machine data, even the virtual machine data that is within the protected portion 312, would remain unencrypted.

The operating system opaque component 314 further causes the encrypted virtual machine data 404 to be made available by allowing the host operating system 305 to access the encrypted virtual machine data 404 (act 604) (such as for externally sending the virtual machine data, or for migrating the virtual machine).

For instance, in FIG. 4, the operating system opaque component 314 controls (as represented by arrow 414), or causes, the host operating system 305 to externally send the encrypted virtual machine data 404. Such sending is represented by the dashed-line arrow 416.

Note that if the decision is to not encrypt the virtual machine data 315 (“No” in decision block 602), then the virtual machine data 315 may simply be made available to the host operating system (act 604) without encryption (act 603). If the hypervisor 320 is the operating system opaque component 314, the hypervisor 320 may cause an encryption component, or encryption firmware, to perform the encryption in block 603.

Once the virtual machine data 315 enters the domain of the host operating system 305 (such as in preparation for sending), the host operating system 305 sees the encrypted form 404 of the virtual machine data 315 but does not see the virtual machine data 315 in the clear.

The making available of the encrypted virtual machine data 404 may result from a migration command to migrate the particular virtual machine 310A to another location. In this case, the operating system opaque component 314 causing the virtual machine data to be encrypted is part of migrating. The migration command may be to send a virtual machine memory space and not the whole virtual machine. Also, the hypervisor 320 may or may not be involved in the migration.

Variations of use for the operating system opaque component 314 may exist. For example, the operating system opaque component 314 may be used for migration only, and not for other purposes, such as I/O purposes. Alternatively, the operating system opaque component 314 may be used for I/O purposes only, and not other purposes, such as migration. Also, the operating system opaque component 314 may be used for both migration and I/O purposes. Another example of I/O purpose would be to store and read data from disk.

FIG. 4 illustrates a specific embodiment in which an operating system opaque component 314 acts on behalf of a single virtual machine 310A running within the host computing system 300. However, the principles described herein may be extended to embodiments in which this or other similar operating system opaque components 314 intercept commands to make virtual machine data available for multiple different virtual machines 310 operating within the host computing system 300. Furthermore, although FIG. 4 illustrates the process associated with making a single item of virtual machine data 315 available to the host operating system, the operating system opaque component 314 may likewise perform a similar process for making available large quantities of virtual machine data.

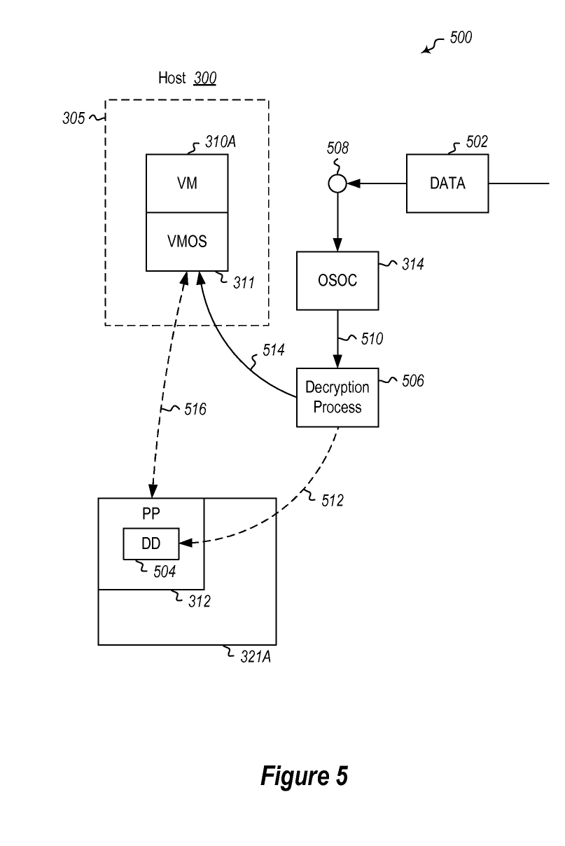

FIG. 5 illustrates an example flow diagram 500 for receiving encrypted data 502. In order to receive, the operating system opaque component 314 receives encrypted data 502 and such remains encrypted while in custody of the host operating system 305. For instance, in FIG. 5, the operating system opaque component 314 receives or detects receipt (as represented by the circle 508) of the encrypted data 502.

When the host operating system 305 detects reception of encrypted data 502 destined for the particular virtual machine 310A from outside of the host computing system 300, the operating system opaque component 314 intercepts (again as represented by circle 508) the encrypted data 502. Interception occurs prior to the virtual machine operating system 311 receiving a decrypted form 504 of the encrypted data 502. The operating system opaque component 314 causes the encrypted data 502 to be decrypted, as shown by process 506. The controlling of the decryption process is represented by arrow 510. Once decrypted, the operating system opaque component 314 causes the decrypted data 504 to be made available to the virtual machine operating system 311. For instance, in FIG. 5, the decrypted data 504 is placed in the protected portion 312 as represented by dashed-line arrow 512.

FIG. 5 illustrates that the same operating system opaque component 314 that was used to send the encrypted virtual machine data in FIG. 4 is being used to decrypt the received data. However, this is not required. A separate component may be used to receive data as compared to sending data. Furthermore, although the operating system opaque component 314 is illustrated as receiving a single piece of data for a single virtual machine 310A, the operating system opaque component 314 may be used to receive a multiplicity of data destined for use by perhaps multiple different virtual machines.

In order to make the decrypted data 504 available to the virtual machine operating system 311, the operating system opaque component 314 may place the decrypted data 504 in the protected portion 312 of host memory 321A allocated for use by the virtual machine operating system 311. The operating system opaque component 314 may further notify (as represented by arrow 514) the virtual machine operating system 311 of a presence of the decrypted data 504, such that the virtual machine operating system 311 may retrieve (as represented by dashed-line arrow 516) the decrypted data 504 from the protected portion 312 of the host memory 321A.

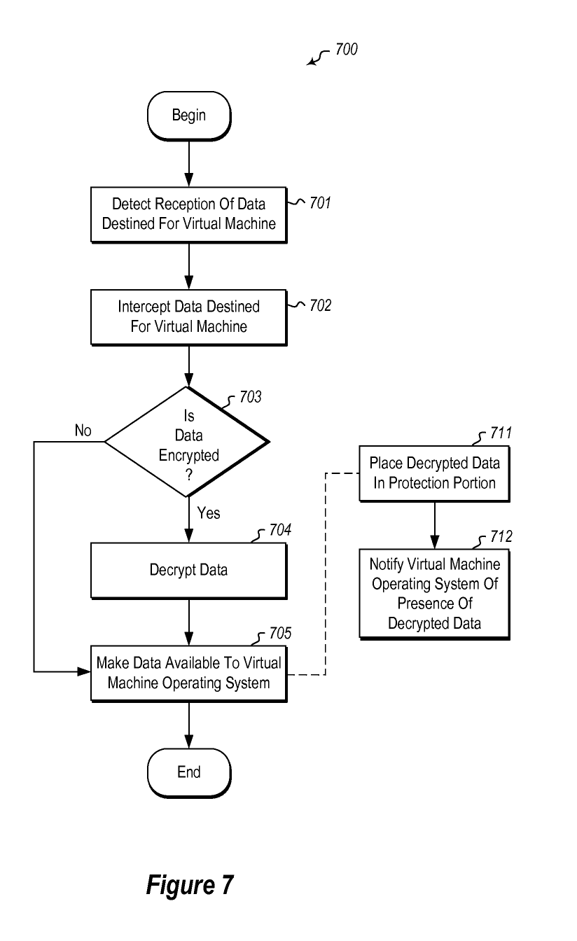

The flow diagram represents flows that may occur when performing a method for receiving encrypted data 502. FIG. 7 illustrates a flowchart of a method 700 for a virtual machine 310A to receive encrypted data 502 that is destined for the virtual machine 310A from outside of the host computing system 300. Accordingly, the flowchart of the method 700 of FIG. 7 will be described along with the data flow 500 of FIG. 5.

Referring to FIG. 7, the reception of data destined for a particular virtual machine 315 is first detected (act 701). For instance, in FIG. 5, data 502 that is destined for the virtual machine 310A is detected by the host operating system 305.

Prior to the virtual machine operating system 311 receiving a decrypted form 504 of the data 502, the operating system opaque component 314 intercepts (act 702) the data 502. The act of intercepting is illustrated in the flow diagram 500 by the circle 508. Similar to the concept of intercepting a comment to make data available to the host operating system, the step of intercepting received data may be performed any number of times in a normal operating state or mode to accumulate data prior to further processing the steps herein.

If the data 502 received is encrypted (“Yes” in decision block 703), then the operating system opaque component 314 responds to this interception by causing the data 502 to be decrypted (act 704). For instance, in FIG. 5, the operating system opaque component 314 controls (as represented by arrow 510) a decryption process 506 to receive the data 502 and formulate a decrypted form of the data 502 (represented as decrypted data 504). If the decision is to not decrypt the data 502 (“NO” in decision block), then the data 502 may simply be made available to the virtual machine operating system 311 (act 705).

The decision regarding whether to decrypt may be a split decision, whereby some data is to be decrypted and the remaining data is to be left encrypted. For example, the data received may include both encrypted data and unencrypted data in which case only the encrypted data is decrypted before making the unencrypted data and decrypted data 504 available to the virtual machine operating system 311.

To make the data available to the virtual machine operating system 311 (act 705), the data 502 may, if not sensitive, be placed in the non-protected portion of host memory 312 that is allocated to the particular virtual machine 310A. If the data 502 contains sensitive information, however, it is still placed in the protected portion 312 of host memory 321A (act 711).

After being placed in the protected portion 312, the virtual machine operating system 311 is notified (as represented by arrow 514) by the operating system opaque component 314 of a presence of the decrypted data 504, such that the virtual machine operating system 311 may retrieve (as represented by arrow 516) the decrypted data 504 from the protected portion 312 of host memory 321A (act 712). Accordingly, a mechanism has been described in which the privacy of virtual machine data is preserved. This is true even if the host operating system is to access the virtual machine data as when receiving and sending virtual machine data, or otherwise making such virtual machine data available to a host operating system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for making virtual machine data available to the host operating system within which operates one or more virtual machines, the method comprising:
an act of operating a particular virtual machine that operates a virtual machine operating system that has access to a protected portion of host memory allocated for use by the virtual machine operating system, the protected portion including the virtual machine data;
an act of an operating system opaque component intercepting a command to make available the virtual machine data in the protected portion of the host memory that is allocated to the particular virtual machine; and
in response to the interception of the command, an act of the operating system opaque component causing the virtual machine data to be encrypted and made available to the host operating system in encrypted form.

2. The method in accordance with claim 1, the command being issued from the virtual machine operating system.

3. The method in accordance with claim 1, the command being a migration command to migrate the particular virtual machine to another location, wherein the act of the operating system opaque component causing the virtual machine data to be encrypted and externally sent is part of the act of migrating.

4. The method in accordance with claim 1, the operating system opaque component comprising a hypervisor.

5. The method in accordance with claim 4, the act of causing the virtual machine data to be encrypted comprising:
an act of the hypervisor causing an encryption component that is also operating system opaque to perform the encryption.

6. The method in accordance with claim 1, the operating system opaque component being a driver registered with the virtual machine operating system.

7. The method in accordance with claim 6, wherein the driver is loaded at or after startup of the virtual machine operating system.

8. The method in accordance with claim 1, the operating system opaque component being a component that is outside of a hypervisor, and performs the act of intercepting a command by receiving the command from the hypervisor in response to the hypervisor receiving the command from the virtual machine operating system.

9. The method in accordance with claim 1, the operating system opaque component being a component within a protected portion of a host partition that cannot be accessed through a normal operating mode of the host operating system.

10. The method in accordance with claim 1, the operating system opaque component emulating physical hardware to the virtual machine operating system.

11. The method in accordance with claim 1, the act of the operating system opaque component causing the virtual machine data to be encrypted and made available including an act of causing the virtual machine data to be externally sent.

12. The method in accordance with claim 1, the act of the operating system opaque component causing the virtual machine data to be encrypted and made available including an act of causing the virtual machine data to be externally sent within a cloud computing environment.

13. The method in accordance with claim 1, the method further comprising:
an act of determining that the virtual machine data is to be encrypted.

14. The method in accordance with claim 13, wherein at least some data within the protected portion of the host memory that is allocated to the particular virtual machine is not to be encrypted.

15. The method in accordance with claim 13, wherein there is at least one circumstance in which the virtual machine data would not be encrypted.

16. The method in accordance with claim 1, the method further comprising:
an act of the host operating system detecting a reception of encrypted data destined for the particular virtual machine from outside of the host computing system;
in response to receiving the encrypted data, prior to the virtual machine operating system receiving a decrypted form of the encrypted data, the operating system opaque component intercepting the encrypted data destined for the particular virtual machine and decrypting the encrypted data; and
an act of the operating system opaque component causing the decrypted data to be made available to the virtual machine operating system.

17. The method in accordance with claim 16, the act of the operating system opaque component causing the decrypted data to be made available to the virtual machine operating system comprising:
an act of placing the decrypted data in the protected portion of host memory allocated for use by the virtual machine operating system; and
an act of notifying the virtual machine operating system of a presence of the decrypted data, such that the virtual machine operating system may retrieve the decrypted data from the protected portion of the host memory allocated for use by the virtual machine operating system.

18. A host computing system that comprises:
one or more processors;
a host memory; and
a computer program product comprising one or more computer-readable storage media having thereon computer-executable instructions that are structured such that, when interpreted by the one or more processors associated with the host computing system, cause the computing system to perform a method when the host computing system has operating thereon one or more virtual machines within a host operating system, the method comprising:
an act of operating a particular virtual machine that operates a virtual machine operating system that has access to a protected portion of host memory allocated for use by the virtual machine operating system, the protected portion including the virtual machine data;
an act of an operating system opaque component intercepting a command to make available the virtual machine data in the protected portion of the host memory that is allocated to the particular virtual machine; and
in response to the interception of the command, an act of the operating system opaque component causing the virtual machine data to be encrypted and made available to the host operating system in encrypted form.

19. A computer program product comprising one or more computer-readable storage media having thereon computer-executable instructions that are structured such that, when interpreted by the one or more processors associated with the host computing system, cause the computing system to perform a method when the host computing system has operating thereon one or more virtual machines within a host operating system, the method comprising:
an act of operating a particular virtual machine that operates a virtual machine operating system that has access to a protected portion of host memory allocated for use by the virtual machine operating system, the protected portion including the virtual machine data;
an act of the operating system opaque component intercepting a command to make available the virtual machine data in the protected portion of the host memory that is allocated to the particular virtual machine; and
in response to the interception of the command, an act of the operating system opaque component causing the virtual machine data to be encrypted and made available to the host operating system in encrypted form.

20. The computer program product in accordance with claim 19, wherein the virtual machine operating system may be changed and updated without affecting the operating system opaque component.
